(19) United States
(12) Patent Application Publication
(10) Pub. No.: US 2017/0074018 A1
(43) Pub. Date: Mar. 16, 2017

(54) ABUTMENT ELEMENT FOR DAMPERS OF SLIDING DOORS

(71) Applicant: BORTOLUZZI SISTEMI S.P.A., Belluno (IT)

(72) Inventors: Guido BORTOLUZZI, Belluno (IT); Bruno SPONGA, Belluno (IT); Adriano GIROTTO, Belluno (IT); Lucio MOLINER, Belluno (IT)

(21) Appl. No.: 15/125,165

(22) PCT Filed: Mar. 27, 2015
(86) PCT No.: PCT/IB2015/052262

§ 371 Date: Sep. 11, 2016

(30) Foreign Application Priority Data
Apr. 1, 2014 (IT) TV2014A000051

(51) Int. Cl. E05F 5/00; E05F 5/02

(52) U.S. Cl. CPC E05F 5/003; E05F 5/02; E05Y 2900/20

(57) ABSTRACT

An abutment element (B1, B2) is described adapted to be arranged on a profile (10) mounted on a furniture item, on the profile being able to slide a shock-absorber that is integral with a door and which is mounted to meet the abutment element to activate. The element has a portion (32, 52) slidably couplable to the profile so that the abutment element can slide on the profile without detaching; and a modifiable structure for creating a constraint to the sliding of the abutment element so as to make it integral with the profile. Thereby easy assembly and lack of screw-hole are assured.

The invention relates to an abutment element for dampers (shock-absorbers) of sliding doors, to a method for its production and assembly.

On certain cabinets there are mounted sliding doors in order to avoid the disadvantages of the hinged ones, i.e. smaller closing surfaces of a compartment and bulky opening radii. Each sliding door is supported by a pair of brackets connected to carriages equipped with wheels sliding inside a rail, formed in a metal profile, arranged on the ceiling of the cabinet. To prevent that an excessive thrust on the door can make it crash into the end-of-travel stop, damping devices (shock absorbers) are used, integral with the door, which are activated only in the final part of the stroke. The damping devices are activated (or deactivated) when, while sliding with the door, they meet locators (called “activators”) fixed to the rail, positioned at appropriate points during assembly of the mechanism (see e.g. US2010071154).

Typically the activators are fixed by screws to the profile. One must not only bore the profile (delicate and expensive operation) but any boring or positioning error can ruin the profile or impose its replacement. Also, it is impossible to remove or move the activator without ruining the profile, and it is very difficult to adjust the position of the activator after any boring (e.g. to compensate for tolerances).

To obviate at least one of these problems is the main object of the invention, which is defined in the appended claims, in which the dependent ones define advantageous variants.

It is proposed therefore a method for anchoring an abutment element to a profile mounted on a furniture item, on the profile being able to slide a shock-absorber, integral with a door, which is activated when it encounters the abutment element, wherein

(ia) the abutment element is slidably coupled to the profile so that the first is able to slide on the second without detaching; and

(iia) the position of the abutment element is fixed on the profile by creating a constraint to its sliding.

It is also proposed a method for producing an abutment element which can be anchored to said profile wherein

(ib) the abutment element is produced slidably couplable to the profile so that the first is able to slide on the second without detaching; and

(iib) the abutment element is produced fixable to the profile by means of the creation of a constraint to its sliding.

Note that the anchoring system for activators and/or the production system extends easily to any other object that one wants to make rigid or integral with the profile without having to intervene by means of a invasive or destructive mechanical connection, e.g. like a screw.

It is also proposed an abutment element, adapted to be arranged on said profile, comprising

a portion slidably couplable to the profile so that the abutment element can slide on the section without detaching;

the element having a modifiable structure for creating a constraint to the sliding of the abutment element so as to make it integral with the profile.

By modifiable structure we here mean that the body or said couplable portion of the abutment element is constructed to modify its shape in order to create said constraint.

The methods and the abutment element speed up the fixing times of the activators to the profile and facilitate the regulation of the same. In fact, one gets rid of screws or invasive fastening means and of the relevant assembly time. Not only one can remove the abutment element without damaging the profile, but since the element itself integrates or comprises means for anchoring/fixing to the profile it can be easily anchored during assembly and by trial and error set into the right position.

The methods and the abutment element have many advantageous variations, and the variants described for one can be implemented for the other.

For example, the step (iia) or (iib) can be obtained through a wedge insertable between the abutment element and the profile, particularly if the step (iib) is obtained by producing the abutment element as two pieces, one of which has a wedge jointable between the profile and a part of the other.

The anchoring or attachment means can also comprise a clamp structure which can be tightened to lock the element on a point of the profile, e.g. the same slidably-couplable portion can have deformable structure or movable jaws to lock on the profile.

As a very simple variant (it requires no moving parts or complex structure, and is very durable and inexpensive) the element can comprise a wedge jointable between the portion and the profile in order to anchor the abutment element to the profile by friction. The frictional force generated by the mutual fitting is therefore exploited.

Preferably the element comprises two pieces, wherein one piece comprises the said portion and the other the wedge, and the pieces are able to be neared to each other to joint the wedge. The two-piece structure implements in a simple but efficient manner the anchoring via a wedge and friction. It also makes the disassembly very easy, sufficing the separation of the two pieces.

Preferably the element comprises an elastic element mounted for pulling the two pieces toward one another. The object is to assure a stable joint and to avoid accidental disconnections.

Preferably said portion has the form of a hook, for a shape-fitting with a complementary guide on the profile, and defines a concavity inside which the wedge is jointable. In this manner the wedge can be located between the profile and the portion in order to block it at a point by friction.

Preferably the wedge and the concavity each have an inclined plane of substantially the same inclination.

To provide such inclined surfaces that abut during the anchoring and create a pressure or compression force between the portion and the profile is an easy way to exploit and enhance the friction as blocking agent. The inclined planes do not weaken the structure of the abutment element and their inclination is a degree of design freedom to determine the dynamics and/or the strength of the anchoring. Some profiles e.g. could be less resistant than others (e.g. made out of plastic) and request more calibrated anchorings.

The advantages of the invention will be more apparent from the following description of preferred embodiments, making reference to the attached drawing in which

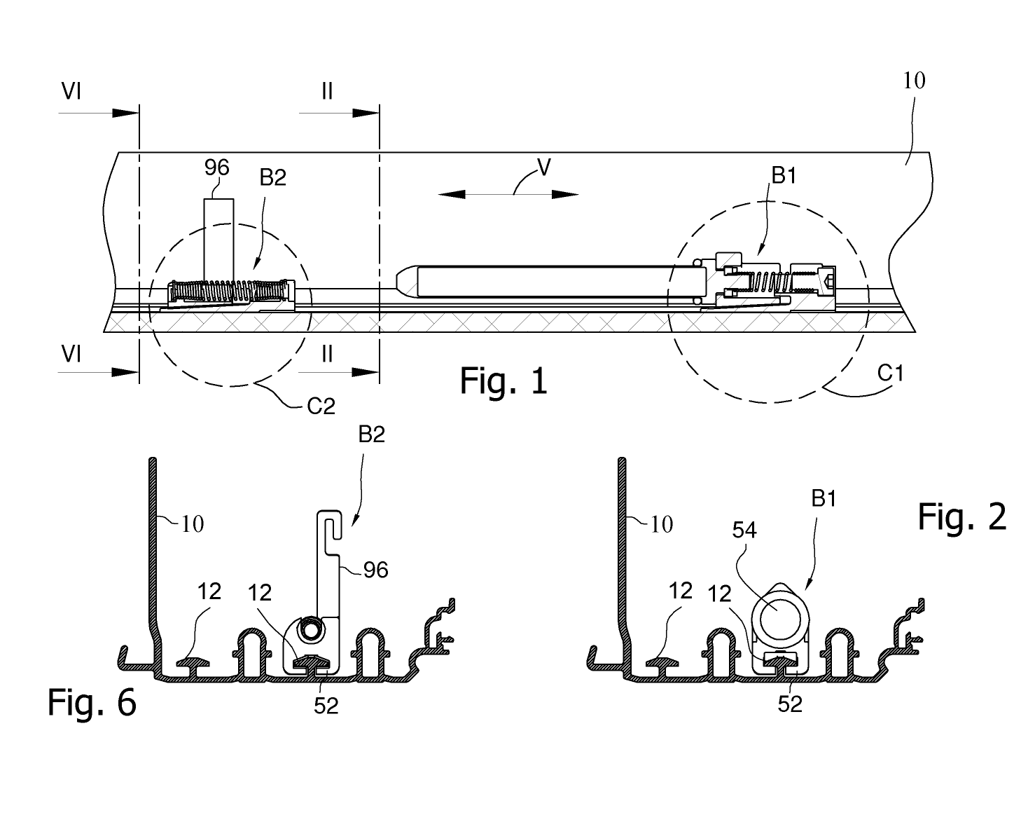

FIG. 1 shows a side view of a profile for sliding doors with two abutment elements mounted on them;

FIG. 2 shows a cross-section along the plane II-II of FIG. 1;

FIG. 3 shows an enlargement of the dotted circle C1 in FIG. 1;

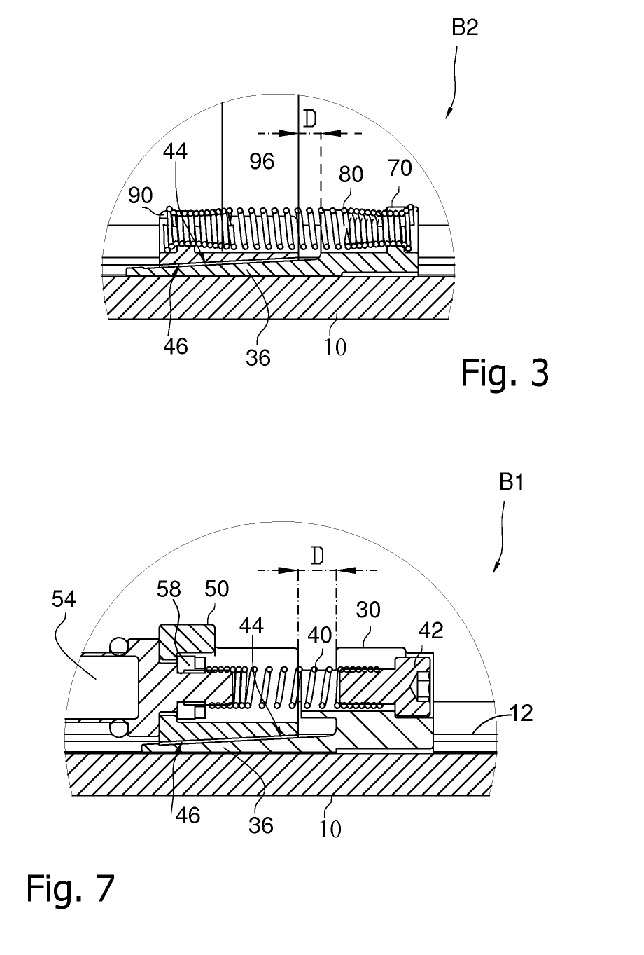

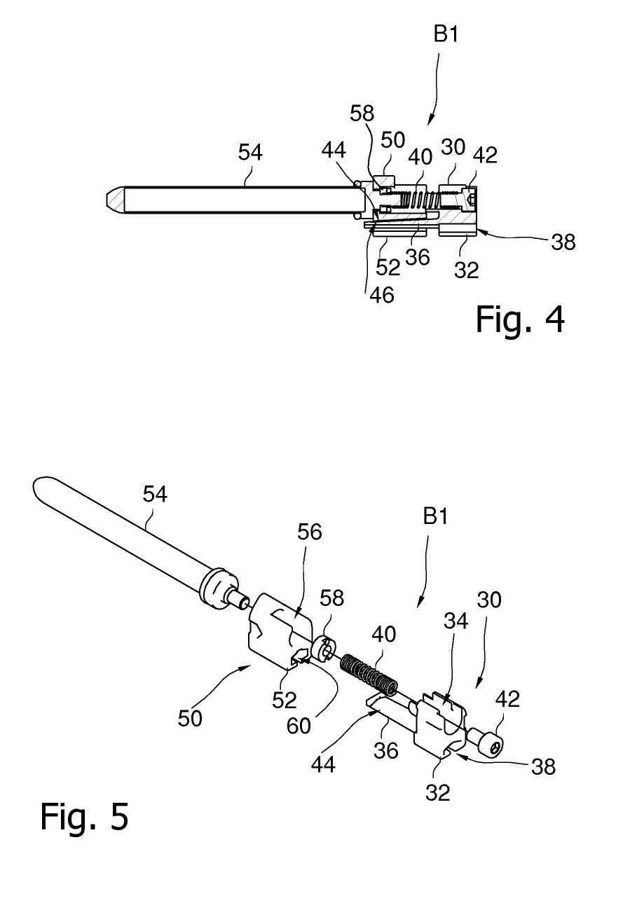

FIG. 4 shows isolated an abutment element seen from a side;

FIG. 5 shows the element of FIG. 4 in exploded view;

FIG. 6 shows a cross-section along the plane VI-VI of FIG. 1;

FIG. 7 shows an enlargement of the dotted circle C2 in FIG. 1;

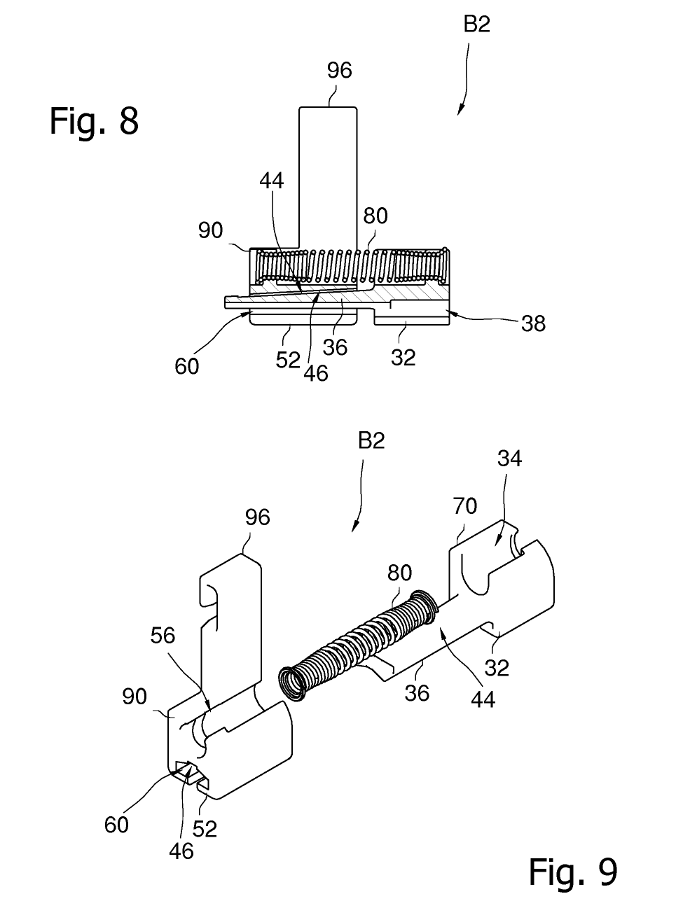

FIG. 8 shows an isolated second abutment element seen from a side;

FIG. 9 shows the element of FIG. 8 in exploded view.

In the figures, identical numbers indicate identical or conceptually similar parts, and the elements are described as being in use.

FIG. 1 shows a profile 10, e.g. made of metal, shaped to constitute guide rails for wheels of sliding carriages to which doors are fixed in a known way. In particular, the profile 10 comprises one or more projections, with T-shaped cross-section, indicated with 12, to which there is slidably fastenable an abutment element B1 (FIGS. 2-5) which is formed by two pieces 30, 50.

The first piece 30 comprises at the base an optional hook-shaped portion 32, in particular a C-shaped cross-section portion, which delimits a seat 38 (e.g. between the two wings of the C). Two upper lateral walls define a seat 34 in which a screw 42 is inserted, while on one side extends an element 36, wedge-shaped, having an inclined plane 44. The inclination is referred to the sliding direction V on the profile 10 (FIG. 1), i.e. parallel to the lying plane of the profile 10.

The second piece 50 comprises at the base a hook-shaped portion 52, in particular with a C-shaped cross-section portion, which delimits a seat 60 between the two wings of the C. The upper wall of the seat 60 is constituted by an inclined plane 46, preferably oriented as the plane 44. Two upper lateral walls define a seat 56 in which is inserted a safety washer 58, while in front of the piece 50 there is fixed or fixable a cylinder 54.

The element 36 has such dimensions that it can be inserted inside the seat 60.

Between the screw and the safety washer 58 there is placed in traction an optional spring 40, so that on the pieces 30, 50 a force is always applied tending to bring them closer to one another. Preferably the seats 60 and 38 have the same geometry.

Operation

When mounting the sliding mechanism for the door, the abutment element B1 is placed at a suitable point along the profile 10. Therefore, the projection 12 is inserted into the seats 60, 38 (FIG. 2) by keeping the pieces 30, 50 slightly away from each other. In this way, the portions 52, 32 embrace the projection 12 and the pieces 30, 50 can slide freely on and along the profile 10 but without being able to detach from it. Note (FIG. 4) that in this configuration the element 36 takes up little space of the seat 60 and does not interfere (the inclined planes 44, 46 do not touch). Reached the established point in which to fix the abutment element B1, the pieces 30, 50 are moved closer to one another, to cause further penetration of the element 36 in the seat 60. The inclined planes 44, 46 slide over one another and the piece 50, pushed by the piece 30, perpendicularly moves away from the profile 10 until the portion 52 abuts and presses against the projection 12. To such pressure corresponds a frictional force between the portion 52 and the projection 12 which stably anchors the element B to the profile 10.

The spring 40 ensures the stable wedging of element 36 inside the seat 60 and/or avoids accidental detachments between the pieces 30, 50 and therefore the loss of grip on the profile 10. However, only forced interlocking can be sufficient.

The shock-absorber of the door (not shown) activates when it ends up touching the cylinder 54.

When one wants to re-move the element B1, it is sufficient to move the pieces 30, 50 apart, e.g. by inserting and then turning a screwdriver pin inside a slot of width D which advantageously is made to remain between the pieces 30, 50 when attached. The pieces 30, 50, for this purpose, can have such a shape that even at maximum reciprocal joint there is a gap between them.

A variant of the abutment element B2, which uses the same principle of construction and assembly and has two pieces 70, 90, is shown in FIGS. 6-9.

Equal parts, indicated by the same references, will not be re-described for the sake of brevity. As previously the pieces 70, 90 have hook portions 32, 52; a wedge 36 with inclined planes 44, 46 which work in the same way, and seats 34, 56 bounded by vertical walls.

The main differences for the element B2 are a different projecting activator element, that is, a vertical hook 96, and an optional helical spring 80 between the pieces 70, 90 which has flared or enlarged ends through the enlargement of some of the windings. Such a spring draws the pieces 70, 90 toward one another because the enlarged ends abut on and push teeth 82, 92 embossed inside the seats 56, 34 of the piece 70, 90 respectively.

It is clear that the assembly system and/or the abutment elements described:
speed up the time for fastening an abutment element to the profile 12;
the position control is much (more) easy,
allow to remove the abutment element without damaging the profile with boring or other;
one can use them without tools, ultimately overall manually.

The invention is open to many variations. E.g. possible variations in the abutment elements with respect to those described are:
different types of activating organs (all the known ones), which can be integral with one or the other of the two pieces that form the abutment element;
an elastic means different from the spring 40, 80, e.g. a plate or cup spring, a rubber band, etc., always with the function of bringing the two pieces closer;
different shapes for the portions 32, 52, e.g. with T-section to make it slide in a C-shaped groove in the profile 10, or generally a portion able to engage through sliding interlocking (a prismatic pair) on a corresponding groove or relief present on the surface of the profile. This portion can be deformable or have variable geometry for anchoring to the profile (e.g. the C-shaped portions can have jaws clampable to tighten the protrusions 12);
different shape or geometry (e.g. length or width) for the element 36 adapted to wedge itself into the seat 60, in particular different shape or inclination of the inclined planes 44, 46.

It is understood, finally, that the anchoring system for the abutment element, with all its variations, can be implemented on any type of known activator, and also to any other component that one wants to make integral to the profile 12 without mechanical screw-connection.

1. Method for anchoring an abutment element (B1, B2) to a profile (10) mounted on a furniture item, on the profile being able to slide a shock-absorber, integral with a door, which is activated when it encounters the abutment element, wherein
(ia) the abutment element is slidably coupled to the profile so that the first is able to slide on the second without detaching; and
(iia) the position of the abutment element is fixed on the profile creating a constraint to its sliding.

2. Method for producing an abutment element which can be anchored to a profile mounted on a furniture item, on the profile being able to slide a shock-absorber, integral with a door, which is activated when it encounters the abutment element, wherein
(ib) the abutment element is produced slidably couplable to the profile so that the first is able to slide on the second without detaching; and
(iib) the abutment element is produced fixable to the profile by creating a constraint to its sliding.

3. Method according to claim 1, wherein the step (iia) or (iib) is obtained through a wedge insertable between the abutment element and the profile.

4. Method according to claim 3, wherein the step (iib) is obtained by producing the abutment element as two pieces, one of which has a wedge jointable between the profile and a part of the other.

5. Abutment element (B1, B2) adapted to be arranged on a profile (10) mounted on a furniture item, on the profile being able to slide a shock-absorber that is integral with a door and which is mounted to meet the abutment element to activate, comprising
a portion (32, 52) slidably couplable to the profile so that the abutment element can slide on the profile without detaching;
the element having a modifiable structure for creating a constraint to the sliding of the abutment element so as to make it integral with the profile.

6. Element according to claim 5, comprising a wedge (36, 44) jointable between the portion and the profile in order to anchor the abutment element to the profile by friction.

7. Element according to claim 6, comprising two pieces (30, 50, 70, 90), wherein one piece comprises the said portion and the other the wedge, the pieces being able to be neared to each other to joint the wedge.

8. Element according to claim 7, comprising an elastic element (40) mounted for pulling the two pieces toward one another.

9. Element according to claim 5, wherein the portion has the form of a hook (32) and defines a concavity (38) inside which the wedge is jointable.

10. Element according to claim 9, wherein the wedge and the concavity each have an inclined plane (44, 46) of substantially the same inclination.
